(19) United States
(12) Patent Application Publication
(10) Pub. No.: US 2006/0200516 A1
(43) Pub. Date: Sep. 7, 2006

(54) Data processing system and method for message handling

(76) Inventors: Dermot Flaherty, Upham (GB); Stephen James Hobson, Hampton (GB); Paul Hopewell, Chandlers Ford (GB); Paul Kettley, Winchester (GB); Peter Siddall, Romsey (GB)

Correspondence Address: Martin J. McKinley;IBM Corporation T81/503, PO Box 12195, Research Triangle Park, NC, 27709, US

(21) Appl. No.: 11/365,410

(22) Filed: Mar. 1, 2006

(30) Foreign Application Priority Data
Mar. 1, 2005 (GB) 0504117.3

(51) Int. Cl. G06F 15/16

(52) U.S. Cl. 709/201; 709/230

(57) ABSTRACT

A data processing system for message handling comprises a coupling facility for receiving messages, the coupling facility arranged to maintain a queue of messages, and a database for storing messages. A component, such as a server, of the system is arranged to detect that a message is of a size above a predetermined threshold, and therefore stores this larger message in the database and enters a proxy in the queue of messages.

### BACKGROUND OF THE INVENTION

This invention pertains to computers and other data processing systems, methods and software and, more particularly, to such systems, programs and processes for message handling.

In message handling systems, it is known to provide a mechanism to store shared messages using a coupling facility as the shared storage. However, the relative cost of such storage makes its use for storing large messages prohibitive. An alternative is to store large messages in some other kind of shared storage, for example a shared database. However, there are drawbacks to this.

Database technologies are not good at handling high update load (all messaging operations are updates), which leads to high lock contention. Database technologies are not good at event driven operations, for example commands such as “give me back control when a message arrives for me” are not handled efficiently by databases.

In a hybrid approach, finding the best (usually oldest, highest priority) message is more problematical when the data is split between different storage mechanisms, and if there are short messages and long messages in the same unit of work, co-ordination of the update between the database (for long messages) and the coupling facility (for short messages) becomes problematical and costly. It is also complex to co-ordinate media recovery between different resource managers after data loss due to a failure.

### SUMMARY OF THE INVENTION

According to a first aspect of the present invention, there is provided a data processing system for message handling comprising a coupling facility for receiving messages, the coupling facility arranged to maintain a queue of messages, and a database for storing messages, a component of the system being arranged to detect that a message is of a size above a predetermined threshold, to store the message of a size above a predetermined threshold in the database and to enter a proxy in the queue of messages.

According to a second aspect of the present invention, there is provided a data processing method for message handling comprising receiving messages, maintaining a queue of messages, storing messages in a separate database, detecting that a message is of a size above a predetermined threshold, storing the message of a size above a predetermined threshold in the database and entering a proxy in the queue of messages.

According to a third aspect of the present invention, there is provided a computer program product on a computer readable medium for controlling a data processing system, the computer program product comprising instructions for receiving messages, maintaining a queue of messages, storing messages in a separate database, detecting that a message is of a size above a predetermined threshold, storing the message of a size above a predetermined threshold in the database and entering a proxy in the queue of messages.

Owing to the invention, it is possible to provide a hybrid mechanism and implementation which overcomes both the cost of storing large messages in coupling facility, and disadvantages of an all database approach.

Advantageously, the proxy is in the form of a key value, and the key value is stored in the database linked to the message of a size above a predetermined threshold. This is the simplest form of linking the large message stored in the database to the proxy stored in the queue of messages in the coupling facility.

Preferably, the system further comprises a plurality of servers, each server being connected to the coupling facility, with the component of the system being arranged to detect that a message is of a size above a predetermined threshold comprising a server. If the server is the component to detect the oversize message and pass it to the database, then the work load of the coupling facility is reduced, and the overall operation of the system is simplified.

Ideally, each server is further arranged, when calling a message from the queue of messages and receiving a proxy, to access the database to recall the corresponding message. Likewise, if the server actions the recall of the large message from the database then resources are saved in the coupling facility. In fact in this arrangement, the coupling facility is unaware of the filtering of messages by the servers, and operates on the proxy as if it was a standard message.

Advantageously, the database cannot be accessed by a component of the system except via a proxy retrieved from the queue of messages. By having a system that restricts access to the database, the overall robustness of the system is increased.

In the system, shared messages longer than some threshold length have the data stored in the database. The data is written and committed to the database immediately, and a reference to the data is held in the coupling facility. This message can be referred to as the parent message. All access to the child message data held in the database is via the parent message held in the coupling facility. The server will search for the most appropriate message solely by reference to the data held in the coupling facility, and when found, lock it using coupling facility operations. This avoids the costly database locks and queue ordering makes location of the ‘oldest highest priority’ message very cheap. All event driven operations are driven by the arrival of ‘committed messages’ in the coupling facility which in turn notifies interested queue managers that they have occurred.

### BRIEF DESCRIPTION OF THE DRAWINGS

Embodiments of the present invention will now be described, by way of example only, with reference to the accompanying drawings, in which:—

FIG. 1 is a schematic view of a data processing system for message handling comprising a coupling facility and a pair of servers,

FIG. 2 is a further schematic view of the data processing system of FIG. 1,

FIG. 3 is a schematic view of the data processing system of FIGS. 1 and 2 with a database, and

FIG. 4 is a view, similar to FIG. 3, of the data processing system.

### DESCRIPTION OF THE PREFERRED EMBODIMENTS

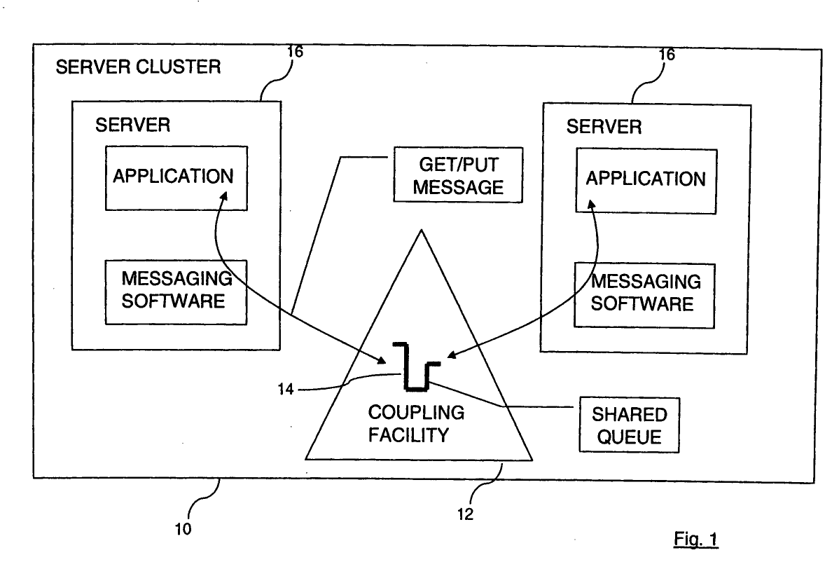

FIG. 1 shows a server cluster 10 which is a data processing system for message handling. The cluster 10 comprises a coupling facility 12 for receiving messages. The coupling facility 12 is arranged to maintain a queue of messages. The system 10 further comprises a plurality of servers 16, each server 16 being connected to the coupling facility 12.

The system 10, in its hardware implementation may consist of several interconnected computers, or may consist of a single machine with different logical functions being carried out by different parts of the machine. The data processing system 10 can be used, for example, for handling a commercial website such as an airline booking system that will handle a large number of transactions such as receiving booking requests from consumers, handling the financial aspects of a request, updating the reservation schedules and so on.

Each server 16, in the system 10, will control and execute one function, for example, with one server being dedicated to maintaining the website front-end with which the consumers interact, another server being dedicated to maintaining financial details of the consumers etc. When a consumer makes a booking through the website, this will generate one or more messages that are placed on the message queue 14 within the coupling facility 12. The servers 16 within the system 10 will then call messages from the queue 14, when they are in a position to carry out the work entailed by the message.

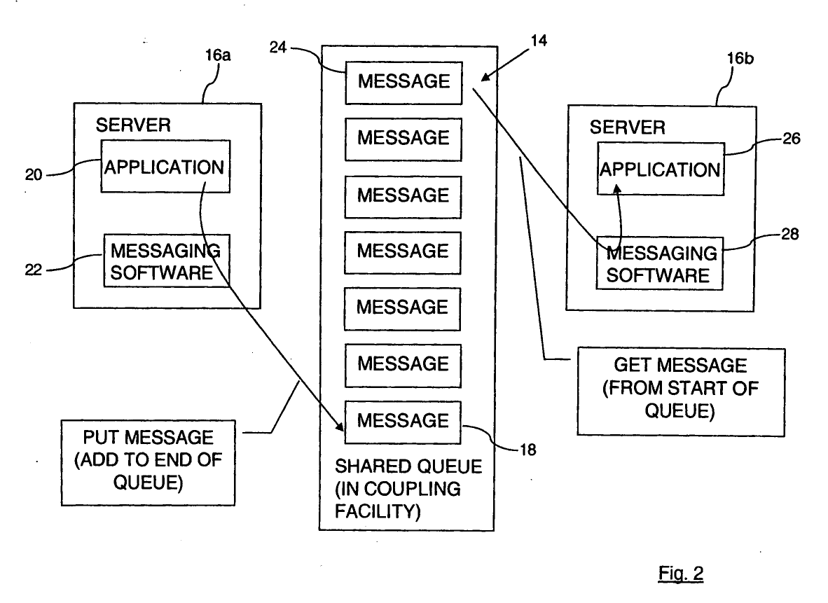

FIG. 2 shows in more detail the flow of messages 18 between the servers 16 and the queue 14. An application 20 being run by the server 16a, such as the website front-end will, via its messaging software 22, put a message 18 onto the end of the queue 14, which is being managed by the coupling facility 12.

The server 16b, which processes the messages 18, will, when it is a condition to do so, get the oldest message 24 from the queue 14. As in the case of the server 16a, the message handling for the application 26 being run by the server 16b will be handled by the messaging software 28, likewise running on the server 16b. Both servers 16 have the ability to put and get messages from the queue 14, and in systems with more than two servers, all of the servers within the system can put and get messages. A typical message flow, is that a first application puts a message and commits it. A subsequent application is waiting for the arrival of a message on the queue. When one arrives it gets the message, performs some processing and commits the work.

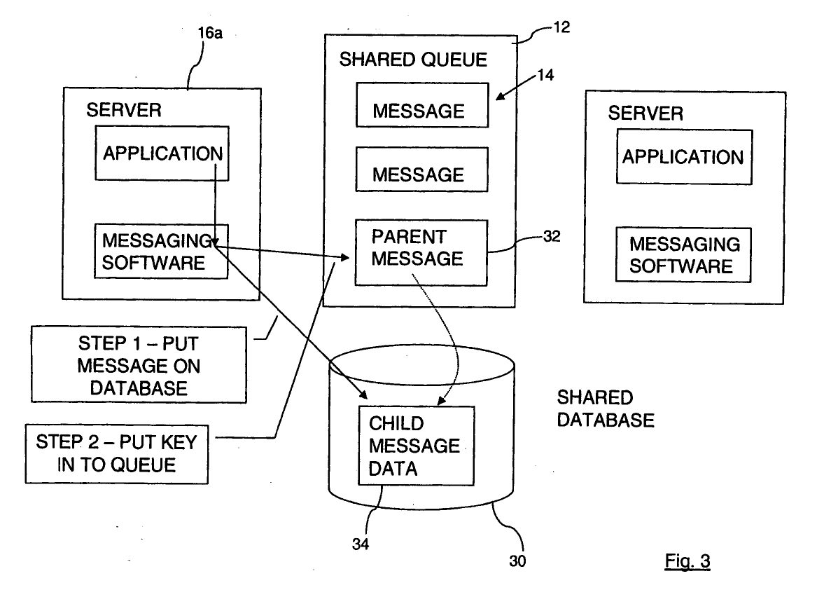

In FIG. 3, a further component of the system 10 is shown, which is a database 30. The database 30 is for storing messages. Within the system 10 a component of the system 10 is arranged to detect that a message is of a size above a predetermined threshold.

In message handling systems, most messages will be of a size of the order of a small number of kilobytes, for example 3 to 5 kb. However in many systems the creation of messages far larger than this size is possible. Messages of a size of 20 MB or above are possible, and within the system 10, a component is required to detect the existence of a message larger than a predetermined size. The threshold may be any suitable value, for example, 20 kb.

In the embodiment shown in FIG. 3, the component of the system 10 that is arranged to detect that a message is of a size above a predetermined threshold is the server 16a, which is the source of the message. The detecting component is arranged to store the message of a size above a predetermined threshold in the database 30 and to enter a proxy 32 in the queue of messages.

Once the server 16a has determined that the message that will be put on the queue exceeds a predetermined threshold, the message 34 is written immediately to the database 30 and committed. A parent message 32 (the proxy) is written to the coupling facility 12. This parent message 32 is stored in the logical queue 14 in the coupling facility 12 in ordering sequence with other short messages 18 and references.

The proxy 32 is in the form of a key value, and the key value is stored in the database 30 linked to the message 34 of a size above a predetermined threshold.

The proxy 32 contains sufficient information to allow keyed retrieval of the full message 34. Retrieval of the parent message 32 from the coupling facility 12 uses the coupling facility primary and secondary keys in an identical manner to the retrieval of short messages held on the same logical queue 14. It also contains information related to expiration of this message.

However, the parent message 32 is not committed until the unit of work (in this case the server 16a) which put the message is committed. The locking of uncommitted data is therefore performed by a common mechanism in the queue manager subsystem. This avoids costly database locking issues and unit of work co-ordination between queue manager (within the coupling facility 12) and database manager.

Likewise, triggering and waking getters blocked on arrival of a message is performed by coupling facility notification to the queue manager that an appropriate message has been committed. There is no requirement for the database to perform this event driven processing.

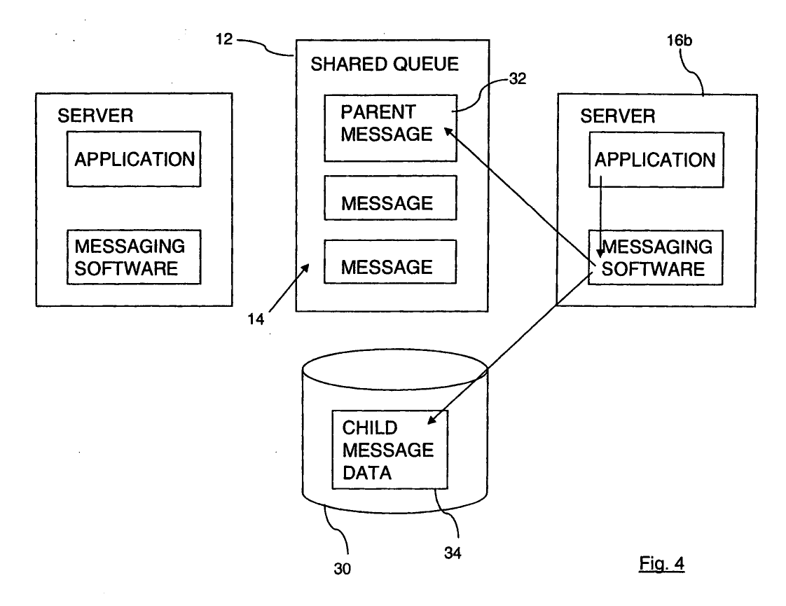

FIG. 4 illustrates the retrieval of the message 34 by the server 16b. The proxy 32 is now in the top position in the queue 14 within the coupling facility 12. This will occur as the messages above the proxy 32 are taken from the queue 14 and processed. A message retriever (a getter), performs all the necessary search functions on the queue 14 that is based in the coupling facility 12. Only when a candidate message has been selected and is found to be a parent message, is the child payload data retrieved from the database 30, by the server 16b.

Each server is arranged, when calling a message from the queue of messages and receiving a proxy 32, to access the database 30 to recall the corresponding message 34. The database cannot be accessed by a component of the system except via a proxy retrieved from the queue of messages.

Deletion of messages in the database 30 occurs only when the getting process commits its unit of work. At this point the child data 34 held in the database 30 is deleted. This deletion of database data does not need to be co-ordinated with the getting unit of work because once the reference to the data held in the coupling facility 12 has been removed, no other task can find the data in the database 30. Since timely removal of the child data 34 in the database 30 is not required. Data deletion can be performed optimized for efficiency, for example in batches at low priority.

The arrangement of the system 10 does not interfere with other common aspects of message systems. For example, a particular type of message retriever is one which notices that messages are expired. This identification of expired messages can be performed without any database access, and so the storage of the child message 34 in the database 30 does not prevent the normal handling of message expiry.

Message data can be stored in an unlogged table in the coupling facility 12. The queue manager understands the semantics of the messages and performs data logging necessary for persistent (recoverable) messages. In the event of data loss, the queue manager takes sole responsibility for recovering message data from its own logs and rebuilding the database information. This makes the recovery process simple to operate.

1. A data processing system for message handling comprising a coupling facility for receiving messages, the coupling facility arranged to maintain a queue of messages, and a database for storing messages, a component of the system being arranged to detect that a message is of a size above a predetermined threshold, to store the message of a size above a predetermined threshold in the database and to enter a proxy in the queue of messages.

2. The system of claim 1, wherein the proxy is in the form of a key value, and the key value is stored in the database linked to the message of a size above a predetermined threshold.

3. The system of claim 1, further comprising a plurality of servers, each server being connected to the coupling facility.

4. The system of claim 3, wherein the component of the system being arranged to detect that a message is of a size above a predetermined threshold comprises a server.

5. The system of claim 3, wherein each server is further arranged, when calling a message from the queue of messages and receiving a proxy, to access the database to recall the corresponding message.

6. The system of claim 1, wherein the database cannot be accessed by a component of the system except via a proxy retrieved from the queue of messages.

7. A data processing method for message handling comprising receiving messages, maintaining a queue of messages, storing messages in a separate database, detecting that a message is of a size above a predetermined threshold, storing the message of a size above a predetermined threshold in the database and entering a proxy in the queue of messages.

8. The method of claim 7, wherein the proxy is in the form of a key value, and the key value is stored in the database linked to the message of a size above a predetermined threshold.

9. The method of claim 7, further comprising communicating with a plurality of servers.

10. The method of claim 9, wherein the step of detecting that a message is of a size above a predetermined threshold is executed by a server.

11. The method of claim 9, wherein each server is further arranged, when calling a message from the queue of messages and receiving a proxy, to access the database to recall the corresponding message.

12. The method of claim 7, wherein the database cannot be accessed by a component of the system except via a proxy retrieved from the queue of messages.

13. A computer program product on a computer readable medium for controlling a data processing system, the computer program product comprising instructions for receiving messages, maintaining a queue of messages, storing messages in a separate database, detecting that a message is of a size above a predetermined threshold, storing the message of a size above a predetermined threshold in the database and entering a proxy in the queue of messages.

14. The computer program product of claim 13, wherein the proxy is in the form of a key value, and the key value is stored in the database linked to the message of a size above a predetermined threshold.

15. The computer program product of claim 13, further comprising instructions for communicating with a plurality of servers.

16. The computer program product of claim 15, wherein the step of detecting that a message is of a size above a predetermined threshold is executed by a server.

17. The computer program product of claim 15, wherein each server is further arranged, when calling a message from the queue of messages and receiving a proxy, to access the database to recall the corresponding message.

18. The computer program product of claim 13, wherein the database cannot be accessed by a component of the system except via a proxy retrieved from the queue of messages.
